(19) United States
(12) Patent Application Publication
(10) Pub. No.: US 2023/0155699 A1
(43) Pub. Date: May 18, 2023

(54) METHODS OF STORING AND RETRIEVING ACTIVE ANTENNA UNIT CALIBRATION DATA AND RELATED ACTIVE ANTENNA MODULES AND METHODS OF CALIBRATING SAME

(71) Applicant: CommScope Technologies LLC, Hickory, NC (US)

(72) Inventors: Chengcheng Tang, Murphy, TX (US); Sammit A. Patel, Dallas, TX (US); XiaoHua Hou, Richardson, TX (US)

(21) Appl. No.: 17/987,031

(22) Filed: Nov. 15, 2022

Related U.S. Application Data
(60) Provisional application No. 63/280,301, filed on Nov. 17, 2021.

(51) Int. Cl. H04B 17/21; H04B 17/11

(52) U.S. Cl. CPC H04B 17/21; H04B 17/11

(57) ABSTRACT

A method of calibrating an active antenna module that includes a radio and an active antenna unit is provide di which information is read from a data storage device that is mounted on the active antenna unit. The radio is connected to the active antenna unit. The radio is calibrated using the information read from the data storage device.

### CROSS-REFERENCE TO RELATED APPLICATION

The present application claims priority under 35 U.S.C. § 119 to U.S. Provisional Patent Application No. 63/280,301, filed Nov. 17, 2021, the entire content of which is incorporated herein by reference.

### BACKGROUND

The present invention generally relates to base station antennas that include active antenna modules and, more particularly, to methods of calibrating such active antenna modules.

Cellular communications systems are well known in the art. In a typical cellular communications system, a geographic area is divided into a series of regions that are referred to as “cells,” and each cell is served by a base station. The base station may include baseband equipment, radios and base station antennas that are configured to provide two-way radio frequency (“RF”) communications with subscribers that are positioned throughout the cell. A base station antenna includes one or more arrays of radiating elements, where each array is a directional device that can concentrate the RF energy that is transmitted or received in certain directions. The “gain” of an array of radiating elements in a given direction is a measure of the ability of the array to concentrate the RF energy in that direction. The radiation pattern that is generated by an array of radiating elements, which is also referred to as an “antenna beam,” is a compilation of the gain of the array across all different directions. Generally speaking, the more radiating elements included in the array, the greater the ability of the array to concentrate the RF energy that is transmitted or received in desired directions.

Base station antennas may include passive antenna arrays and/or active antenna modules. A passive antenna array refers to an array of radiating elements that is configured to generate static antenna beams that have a fixed shape (except for occasional changes to the electronic downtilt angle of the antenna beams) in response to RF signals received from an external radio. The antenna beams generated by a passive antenna array are typically designed to provide coverage to a desired area, such as a sector (e.g., a 120° sector in the azimuth plane) of a cell. In contrast, an active antenna module refers to the combination of a radio unit that includes a beamforming radio and an active antenna unit that includes a multi-column array of radiating elements. The radio unit and the active unit are configured so that together they perform active beamforming. In an active antenna module, the output ports of the beamforming radio are coupled to respective sub-groups of one or more of the radiating elements in the multi-column array of radiating elements. The beamforming radio adjusts the amplitudes and phases of the sub-components of an RF signal that are output at each port of the radio so that the groups of radiating elements work together to, for example, form more focused, higher gain antenna beams that have narrowed beamwidths in the azimuth and/or elevation planes. The electronic adjustment of the amplitudes and phases by the beamforming radio may also be used to “steer” the boresight pointing direction of each generated antenna beam in a desired direction. With active beamforming, the shape of the antenna beams generated by an active antenna module may be varied, for example, on a time slot-by-time slot basis. Active antenna modules may be used as standalone antennas or may be mounted on other antennas (e.g., antennas that include a plurality of passive antenna arrays).

Unfortunately, even small unintended variations in the relative amplitudes and phases of the sub-components of an RF signal that are transmitted through an active antenna module can dramatically affect the gain of the resultant antenna beam. Such unintended variations may arise due to static factors (such as small unintended variations in the lengths of the transmission paths between the radio ports and the radiating elements that result in phase variations) or due to dynamic factors (such as non-uniform temperature changes or non-linearities in the amplifiers that are used to amplify the respective transmitted and received signals). When such unintended variations in the relative amplitudes and phases of the sub-components of an RF signal are present, the resulting antenna beams will typically exhibit lower antenna gains in desired directions and higher antenna gains in undesired directions, resulting in degraded performance.

In order to reduce the impact of the above-discussed amplitude and phase variations, active antenna modules may include a calibration circuit that samples each sub-component of an RF signal and passes these samples back to the radio. The calibration circuit may comprise a plurality of directional couplers, each of which is configured to tap RF energy from a respective one of the RF transmission paths that extend, for example, between the input ports to an active antenna unit of an active antenna module and the groups of one or more radiating elements thereof, as well as a calibration combiner that is used to combine the RF energy tapped off of each of these RF transmission paths. The output of the calibration combiner is coupled to a calibration port of the active antenna unit, which in turn is coupled back to the radio. The radio may use the samples of each sub-component of the RF signal to determine the actual amplitude and phase of each of the sub-components of the RF signal that are transmitted along the respective RF transmission paths through the active antenna unit, and may then adjust the amplitude and phase weights that are applied in the radio to account for unintended variations from intended values for the amplitude and phase of each of the sub-components of the RF signal. Calibration circuitry may also be provided in the radio unit to detect and compensate for unintended changes in the relative amplitudes and phases of the sub-components of RF signals that are output at each port of the radio unit.

An active antenna module can be provided as a single integrated unit or may alternatively be provided as two or more stackable units such as, for example, a radio unit that includes a radio and calibration circuitry and an antenna unit that includes a multi-column active antenna array (e.g., a massive multi-input-multi-output (mMIMO) array of radiating elements) and a filter network, and these units may stackably attach together. In some cases, a single entity may manufacture the entire active antenna module. In other cases, however, different entities may manufacture different components of the active antenna module. For example, in some cases a first entity may manufacture the radio unit and a second entity may manufacture the active antenna unit.

### SUMMARY

Pursuant to embodiments of the present invention, methods of calibrating an active antenna module are provided. The active antenna module may include a radio unit and an active antenna unit. Information is read from an electronically readable data storage device that is mounted on the active antenna unit, and the radio unit is connected to the active antenna unit. A radio of the radio unit is calibrated using the information read from the electronically readable data storage device.

In some embodiments, the information read from the electronically readable data storage device may be calibration data for the active antenna unit. This calibration data may be stored in the radio unit. In some embodiments, the calibration data may be amplitude and phase data for each of a plurality of RF transmission paths through the active antenna unit.

In some embodiments, the information read from the electronically readable data storage device may be an address of a location where calibration data for the active antenna unit is electronically stored. In such embodiments, the calibration data may be downloaded from the location and stored in the radio unit. The calibration data may be amplitude and phase data for each of a plurality of RF transmission paths through the active antenna unit.

In some embodiments, the electronically readable data storage device may be mounted to the active antenna unit using an adhesive. In such embodiments, the electronically readable data storage device may be a barcode sticker or a QR code, and the adhesive may be an adhesive backing on the barcode or QR code sticker. In other embodiments, the electronically readable data storage device may be a near field communication tag.

In some embodiments, the electronically readable data storage device may be a barcode or a QR code, and reading information from the electronically readable data storage device may comprise scanning the barcode or the QR code.

In some embodiments, the radio unit may include an embedded scanner, and reading information from the electronically readable data storage device may comprise using the embedded scanner to read the information from the electronically readable data storage device.

Pursuant to further embodiments of the present invention, active antenna units are provided that comprise an active antenna array, a filter network coupled to the active antenna array, and an electronically readable data storage device mounted on the active antenna unit. Calibration data for the active antenna array or identification of a location where the calibration data for the active antenna array is electronically accessible is stored in the electronically readable data storage device.

In some embodiments, the calibration data for the active antenna array may be stored in the electronically readable data storage device. In other embodiments, an address of the location where the calibration data for the active antenna array is electronically accessible may be stored in the electronically readable data storage device.

In some embodiments, the calibration data may be amplitude and phase data for each of a plurality of RF transmission paths through the active antenna unit.

In some embodiments, the electronically readable data storage device may be mounted to the active antenna unit using an adhesive.

In some embodiments, the electronically readable data storage device may be a barcode sticker, and the adhesive may be an adhesive backing on the barcode sticker. In other embodiments, the electronically readable data storage device may be a QR code sticker, and the adhesive may be an adhesive backing on the QR code sticker. In still other embodiments, the electronically readable data storage device may be a near field communication tag.

In some embodiments, the active antenna unit may be provided in combination with a radio unit that includes an embedded scanner.

### BRIEF DESCRIPTION OF THE DRAWINGS

FIG. 1A is a schematic block diagram of an active antenna module according to embodiments of the present invention.

FIG. 1B is an exploded perspective view of an example implementation of the active antenna module of FIG. 1A.

FIG. 1C is an exploded rear view of a passive base station antenna with the active antenna module of FIG. 1B mounted thereon.

FIG. 2A is a perspective view of an active antenna unit according to embodiments of the present invention.

FIG. 2B is a perspective view of a radio unit according to embodiments of the present invention.

FIG. 2C is a perspective view of the active antenna unit of FIG. 2A mated with the radio unit of FIG. 2B.

FIG. 3A is a front view of a bar code that may be used to store active antenna unit calibration data according to embodiments of the present invention.

FIG. 3B is a front view of a QR code that may be used to store active antenna unit calibration data according to embodiments of the present invention.

FIG. 3C is a perspective view of a near field communication tag that may be used to store active antenna unit calibration data according to embodiments of the present invention.

FIG. 4 is a flow chart illustrating a method of calibrating an active antenna module according to embodiments of the present invention.

FIG. 5 is a schematic block diagram of an active antenna module according to further embodiments of the present invention.

### DETAILED DESCRIPTION

As described above, in some cases, a first entity may manufacture the active antenna unit of an active antenna module, while a second entity may manufacture the radio unit thereof. In many cases, the active antenna unit and the radio unit may each include a calibration port and calibration circuitry, so that the above-described calibration operations may occur to identify the relative amplitude and phase variations along each RF transmission path. However, in some cases, the calibration function will be built into the radio unit, and will be configured to only perform calibration along the transmission paths within the radio unit. As a result, neither the active antenna unit or the radio unit includes a calibration port, and instead the calibration data for the active antenna unit is provided separately to the entity manufacturing the radio unit and is then stored within the radio unit. For example, the calibration data may be sent by email to the entity that manufactures the radio unit or may be uploaded to a secure webpage and the entity manufacturing the radio unit may retrieve the information from the webpage based on the serial number of the active antenna unit. However, these traditional techniques for providing the calibration data to the entity manufacturing the radio unit may be cumbersome and time consuming, and provide opportunities for mistakes that can result in miscalibration of the active antenna module.

Pursuant to embodiments of the present invention, improved techniques are provided for a first entity manufacturing an active antenna unit to provide calibration data for the active antenna unit to a second entity that manufactures the radio unit that is deigned to work with the active antenna unit. According to these techniques, the calibration data may be stored in an electronically readable data storage device that is mounted on or within the active antenna unit, or identification information may be stored in the data storage device that can be used to access the calibration data. The electronically readable data storage device may comprise, for example, a barcode, a QR code, or a near field communication tag. The entity manufacturing the radio unit may read the calibration data directly from the data storage device, if it is stored therein, or may read the information that can be used to access the calibration data (e.g., a hyperlink to a specific internet address where the calibration is electronically stored) from the electronically readable data storage device to access the calibration data. The calibration data, whether read directly from the electronically readable data storage device or retrieved from another location based on information read from the electronically readable data storage device, may then be downloaded into a memory of the radio unit so that the calibration operations will take into account the differences in the RF transmission paths through the active antenna unit.

According to some embodiments of the present invention, methods of calibrating an active antenna module are provided. The active antenna module may include a radio unit and an active antenna unit. Information is read from an electronically readable data storage device that is mounted on the active antenna unit. The radio unit is connected to the active antenna unit. A radio of the radio unit is calibrated using the information read from the electronically readable data storage device.

The information read from the electronically readable data storage device may be calibration data for the active antenna unit or an address of a location where calibration data for the active antenna unit is electronically stored so that the calibration data may be retrieved from that location. Once obtained, the calibration data may be stored in the radio unit. In some embodiments, the calibration data may be amplitude and phase data for each of a plurality of RF transmission paths through the active antenna unit. In some embodiments, the electronically readable data storage device may be mounted to the active antenna unit using an adhesive. In such embodiments, the electronically readable data storage device may be a barcode sticker or a QR code, and the adhesive may be an adhesive backing on the barcode or QR code sticker. In other embodiments, the electronically readable data storage device may be a near field communication tag.

According to additional embodiments of the present invention, active antenna unit are provided that comprise an active antenna array, a filter network coupled to the active antenna array, and an electronically readable data storage device mounted on the active antenna unit. Calibration data for the active antenna array or identification of a location where the calibration data for the active antenna array is electronically accessible is stored in the electronically readable data storage device. The electronically readable data storage device may be a barcode, a QR code or an NFC tag in example embodiments, and the data storage device may be implemented as a sticker that is adhered to the active antenna unit.

Embodiments of the present invention will now be discussed in further detail with reference to the attached drawings.

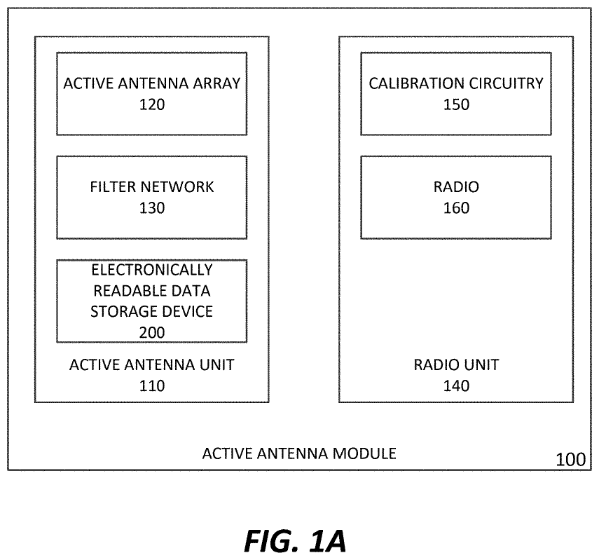

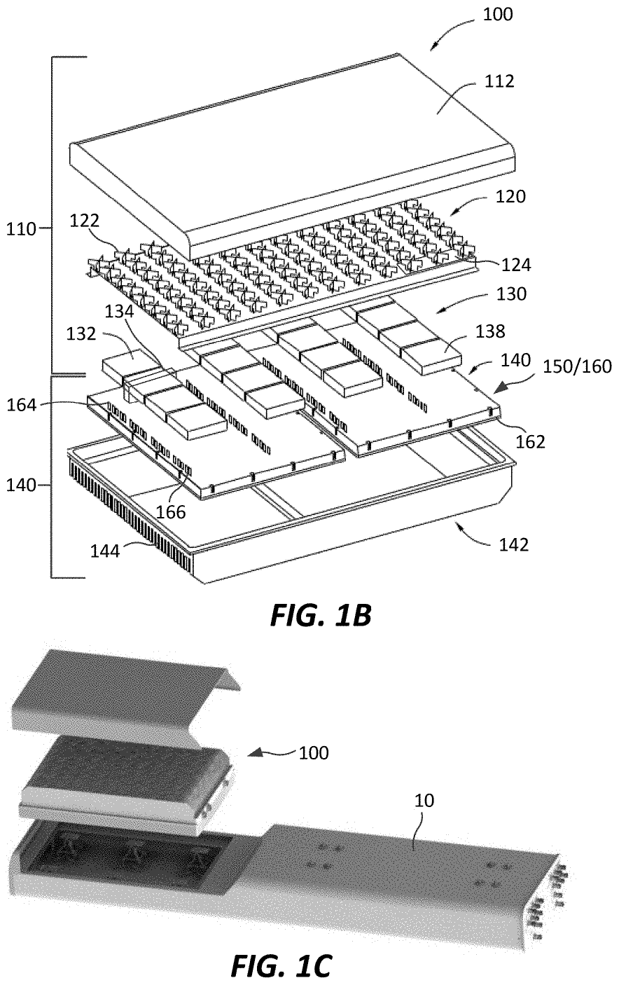

FIG. 1A is a block diagram of an active antenna module 100. As shown in FIG. 1A, the active antenna module 100 includes an active antenna unit 110 and a radio unit 140. The active antenna unit 110 includes an active antenna array 120, a filter network 130, and an electronically readable data storage device 200. The radio unit 140 includes calibration circuitry 150 and a radio 160. Outputs of the radio 160 may be coupled to inputs of the filter network 130, and outputs of the filter network 130 may be coupled to inputs of the active antenna array 120.

The calibration circuitry 150 may be configured to measure the relative amplitudes and phases along at least portions of each RF transmission path in the active antenna module 100. For example, if the active antenna module 100 is configured to operate as a 64 transmit/64 receive (64T/64R) massive MIMO active antenna, the calibration circuitry 150 may be used to determine the relative amplitudes and phases along at least portions each of the 64 RF transmission paths through the active antenna module 100. Typically, it is necessary to determine the relative amplitudes and phases along each of the 64 transmission paths at a number of different frequencies throughout the operating frequency band for the active antenna module 100 as the relative amplitudes and phases may vary as a function of frequency.

In some active antenna modules, calibration circuitry may be provided in both the radio unit 140 and in the active antenna unit 110. In such implementations, the radio unit 140 and the active antenna unit 110 may each include one or more calibration ports (not shown) so that calibration signals may be transmitted between the radio unit 140 and the active antenna unit 110. When such calibration ports are provided, the radio 160 may generate calibration signals that are transmitted through both the radio 160 and the active antenna unit 110 that are used to measure the relative amplitudes and phases along each of the RF transmission paths. In such an arrangement, the calibration circuitry may dynamically calibrate the radio 160 based on changes in the relative amplitude and phases that may occur anywhere along the RF transmission paths (i.e., on portions of the RF transmission paths that are in the radio unit 140 as well as portions that are in the active antenna unit 110).

The unintended variation in the relative amplitude and phases that may occur along the portions of the RF transmission paths that are in the active antenna unit 110 may tend to be relatively static, as there are no active electronic elements along these portions of the RF transmission paths. While the radio 160 will still require calibration data for the portions of the RF transmission paths in the active antenna unit 110 as manufacturing tolerances will meaningfully impact the relative amplitude and phases, it is typically possible to measure the relative amplitude and phases along each RF transmission path through the active antenna unit 110 one time and to then store that calibration data in the radio unit 460. This allows the calibration circuit 150 to perform dynamic calibration with respect to the portions of the RF transmission paths in the radio 160, and to use the static calibration data provided for the portions of the RF transmission paths in the active antenna unit 110 each time calibration is performed. Such a design eliminates the need for calibration ports on the radio unit 140 and the active antenna unit 110, and also eliminates the need for the calibration circuitry 150 to be partially implemented in the active antenna unit 110.

When dynamic calibration is only performed within the radio 160 and static calibration data is used for the active antenna unit 110, it is necessary to store the static calibration data for the active antenna unit 110 within the radio unit 140 (or in another location where the data is accessible by the radio 160). The techniques according to embodiments of the present invention provide new and improved ways for providing the calibration data to a manufacturer of the radio unit 140.

FIG. 1B is an exploded perspective view of an example implementation of the active antenna module 100 of FIG. 1A. The active antenna module 100 of FIG. 1B does not include calibration ports on either the active antenna unit 110 or the radio unit 140. As such, some means for providing calibration data for the active antenna unit 110 is necessary so that such calibration data may be stored in the radio unit 140.

As shown in FIG. 1B, the radio unit 140 includes a housing 142 that provides environmental protection to the radio 160 and calibration circuitry 150. The housing 142 may also include heat dissipation fins 144 or other heat dissipation structures that are used to vent heat generated by the radio 160 from the active antenna module 100. The radio 160 is mounted within the housing 142. In the depicted embodiment, the radio 160 comprises circuit elements (not visible in FIG. 1B) that are mounted on a pair of printed circuit boards 162. Electromagnetic shields 164 are mounted to cover the circuit elements of the radio 160. RF outputs 166 extend through the electromagnetic shields 164. The RF outputs 166 may comprise, for example, blind mate coaxial connectors, pogo pin connectors or the like. In the depicted embodiment, each half of the radio 160 includes two columns of RF output pins 166, where each column has four group of five RF output pins 166. Four of five the RF output pins 166 in each group may carry RF output signals from the radio 160, while the fifth output pin 166 is a ground pin 166 that may carry a common electrical ground signal that is associated with all four RF output signals.

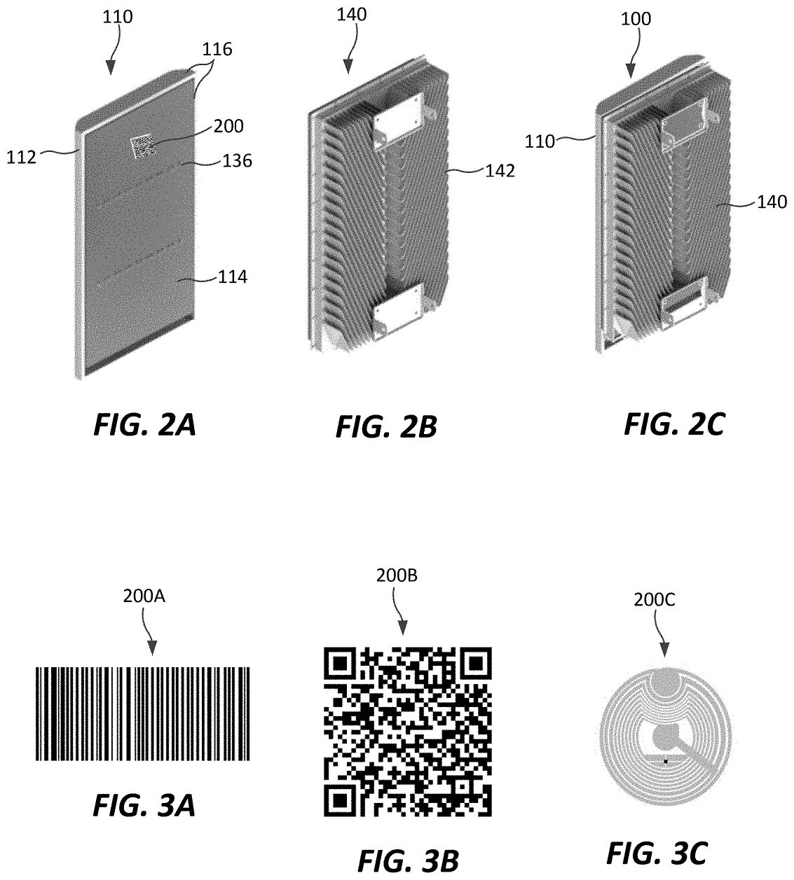

As is further shown in FIG. 1B, the active antenna unit 110 includes the active antenna array 120 and the filter network 130. The filter network 130 is implemented as a bank of sixteen resonant cavity filter units 132, where each filter unit 132 includes four separate resonant cavity filters 134. Each resonant cavity filter 134 has an input 136 (not visible in FIG. 1B, but see FIG. 2A) that is coupled to a respective one of the RF output pins 166 of the radio 160, and each filter unit 134 further includes a ground connection (not shown) that connects to a respective one of the ground pins of the radio 160. Each filter 134 also includes a filter output 138. Each filter output 138 is coupled to the active antenna array 120. The active antenna array 120 includes eight columns of dual-polarized radiating elements 122. Each column includes a total of twelve radiating elements 122, and includes three feed board printed circuit boards 124, where three radiating elements 122 are mounted on each feed board 124 (only one of the feed boards 124 is shown in FIG. 1B to simplify the figure). Each filter output 138 is coupled to a respective pair of feed boards 124 (where the pair of feed boards 124 are adjacent feed boards 124 in the same column) so that the RF signals output through the filter output 138 are coupled to the six radiating elements 122 that are mounted on the pair of feed boards 124. Two filter outputs 138 are coupled to each pair of feed boards 124, where the first filter output 138 feeds RF signals to first polarization radiators of the six radiating elements 122 (e.g., −45° dipole radiators) that are mounted on the pair of feed boards 124, and the second filter output 138 feeds RF signals to second polarization radiators of the six radiating elements 122 (e.g., +45° dipole radiators). While not shown in FIG. 1B, the active antenna unit 110 may further include electromechanical phase shifters in some cases that may be used to adjust a downtilt angle of the antenna beams generated by the active antenna unit 110.

The active antenna module 100 may be used as a stand alone antenna. However, in some cases the active antenna module 100 may be mounted on a passive base station antenna 10, as is shown schematically in FIG. 1C, which is an exploded rear view of the passive base station antenna 10 with the active antenna module 100 mounted thereon.

FIGS. 2A-2C are perspective views of the active antenna module 100 of FIG. 1B in various states of assembly. In particular, FIG. 2A is a perspective view of the active antenna unit 110 in its assembled state, FIG. 2B is a perspective view of the radio unit 140 in its assembled state, and FIG. 2C is a perspective view of the active antenna unit 110 mated with the radio unit 140 to form the active antenna module 100.

As shown in FIG. 2A, the active antenna unit 110 includes the radome 112 as well as a back plate 114 (which is not shown in FIG. 1B). The radome 112 and the back plate 114 may together form a housing 116. The active antenna array 120 and the filter network 130 are mounted within the housing 116. The housing 116 may provide environmental protection to the active antenna array 120 and the filter network 130. The input ports 136 for the filters 132 may extend through the back plate 114. As shown in FIGS. 2B and 2C, the radio unit 140 may have a similar size to the active antenna unit 110. The back plate 114 of the active antenna unit 110 may be mated to the front surface of the radio unit 140 to form the active antenna module 100.

As discussed above, pursuant to embodiments of the present invention, the active antenna unit 110 may include an electronically readable data storage device 200 mounted thereon. The electronically readable data storage device 200 may be mounted on an exterior surface of the housing 116 of active antenna unit 100 in some embodiments, although in other cases it may be mounted within the housing 116. In some embodiments, the electronically readable data storage device 200 may have calibration data for the active antenna unit 110 stored therein. The calibration data may comprise, for example, amplitude and phase data for each of the sixty-four RF transmission paths through the active antenna unit 110. As noted above, such amplitude and phase data may be provided for multiple frequencies within the operating frequency band of the active antenna module 100. The electronically readable data storage device may also include additional information such as, for example, the amplitude and phase weights that will generate certain antenna patterns such as various service beam patterns. The calibration data and other information may be encoded in a specific format in order to minimize the amount of memory required to store the calibration data and other information.

While in some embodiments, the calibration data (and any additional information) may be stored in the electronically readable data storage device 200. However, depending upon the storage capacity of the electronically readable data storage device 200 and the amount of calibration data that must be stored, it may not be possible to fit all of the calibration data within the electronically readable data storage device 200. In this situation, one solution is to mount multiple electronically readable data storage devices 200 on the active antenna unit 110, storing a portion of the data in each data storage device. Another solution is to store an identifier in the electronically readable data storage device 200 that at least in part identifies a location where the calibration data is stored. For example, in some embodiments, the identifier may comprise an internet address or a hyperlink that identifies where the calibration data may be accessed.

FIGS. 3A-3C are front views of examples of electronically readable data storage devices according to embodiments of the present invention. As shown in FIG. 3A, in some embodiments, the electronically readable data storage device 200 may be implemented as a barcode 200A. The barcode 200A may comprise a substrate such as a piece of paper that has a one-dimensional barcode 200A printed thereon. The one-dimensional barcode comprises a series of bars and spaces of varying width. Several of the bars and spaces on either end of the series of bars and spaces may act as start and stop characters, while the bars and spaces in between the start and stop characters may be used to store data. The barcode may also include one or more bars/spaces that serve as an error detection code (e.g., as a parity bit). The barcode 200A may be read using a special type of optical scanner known as a barcode reader, that can read the stored data from the barcode 200A. As described above, the stored data may comprise calibration data for an active antenna unit 110 or an identifier that at least in part identifies where such calibration data is stored.

As shown in FIG. 3B, in other embodiments, the electronically readable data storage device 200 may be implemented as a QR code 200B. The QR code 200B may comprise a substrate such as a piece of paper that has a two-dimensional barcode printed thereon. One-dimensional barcodes such as barcode 200A typically can store less than one hundred characters of data, and hence their data storage capacity is typically insufficient for storing all of the calibration data. For example, the calibration data may comprise relative amplitude and phase values for sixty-four RF transmission paths, for multiple different frequencies (e.g., ten frequencies). Each amplitude and phase value may comprise, for example, about five characters, meaning that the calibration data in this example may require over six thousand characters. QR codes are two-dimensional structures that can store much larger amounts of data, such as about fifteen hundred characters. Thus, in many cases (and particularly for active antenna arrays having sixteen or thirty-two transmission paths, one or a small number (e.g., two to four) QR codes 200B may be sufficient to store the calibration data.

As shown in FIG. 3C, in still other embodiments, the electronically readable data storage device 200 may comprise a near field communication (“NFC”) tag 200C. NFC tags are passive data storage devices that can store relatively large amounts of data (e.g., between about one thousand and fifteen thousand characters). An NFC scanner can read data from the NFC tag 200C via inductive coupling. The NFC tag 200C may comprise an electronic circuit that includes a memory, a radio and an antenna. Each of these components may be formed on a substrate, which can comprise paper or plastic having an adhesive backing so that the NFC tag 200C may be adhered to another surface (e.g., the housing 116 of the active antenna unit 110).

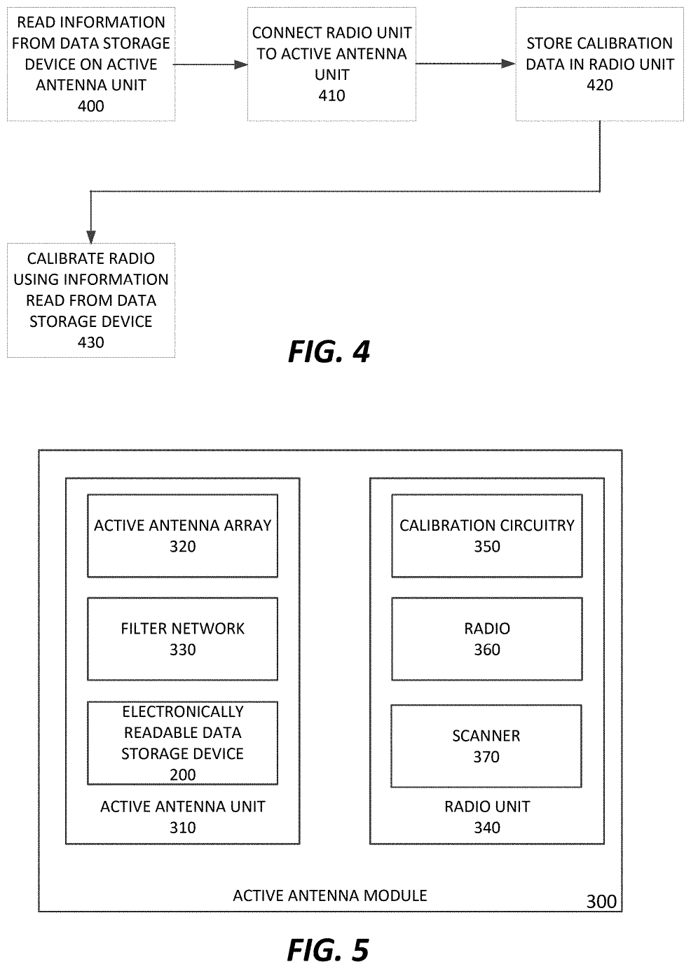

FIG. 4 is a flow chart illustrating a method of calibrating an active antenna module according to embodiments of the present invention. As shown in FIG. 4, information may be read from an electronically readable data storage device that is mounted on an active antenna unit (Block 400). The information that is read from the electronically readable data storage device may comprise, for example, calibration data for the active antenna unit or an address of a location where the calibration data is electronically stored and can be accessed. The information may include additional data such as, for example, optimized amplitude and phase weights for achieving certain antenna patterns. In some embodiments, the information may, for example, be manually read by having a technician use a scanner to read the information from the electronically readable data storage device. In other embodiments, the radio unit of the active antenna module may include an embedded scanner that automatically reads the information from the electronically readable data storage device.

As is further shown in FIG. 4, the active antenna unit and the radio unit may be mated together to form the active antenna module (Block 410). This may be done before or after the calibration data or other information is read from the electronically readable data storage device. If the information stored in the electronically readable data storage device is an address of a location where the calibration data is electronically stored, the calibration data may be accessed from that location. The calibration data may then be stored in the radio unit (Block 420). The radio may be calibrated using the information read from the electronically readable data storage device (Block 430).

Referring to FIG. 5, pursuant to further embodiments of the present invention, active antenna modules 300 are provided which include an active antenna unit 310 and a radio unit 340. The active antenna unit 310 may be identical to the active antenna unit 110 discussed above and hence further description thereof will be omitted here. The radio unit 340 may be similar to the radio unit 140 discussed above, but may further comprise an embedded scanner 370 that is capable of reading the information stored in the electronically readable data storage device 200 that is mounted on active antenna unit 310. For example, if the electronically readable data storage device 200 is a barcode 200A or a QR code 200B, the embedded scanner 370 may comprise an optical scanner. If the electronically readable data storage device 200 is an NFC tag 200C, the embedded scanner 370 may comprise an NFC reader. The embedded scanner 370 may be mounted in a location where it will be directly adjacent the electronically readable data storage device 200 when the active antenna unit 310 and the radio unit 340 are mated to form the active antenna module 300. The radio unit 340 may be configured so that the embedded scanner 370 is automatically activated to read the information from any nearby electronically readable data storage device 200 if, for example, certain predetermined conditions are met (e.g., each time the radio 360 is powered on or when the radio 360 is powered on if calibration data has not already been stored in the radio unit 340).

Having an embedded scanner 370 in the radio unit 340 may be particularly useful in situations where field replacement of part of the active antenna module 300 is required. For example, there may be situations where a wireless operator may wish to replace the active antenna unit 310 of an active antenna module 300 that is already in use in a cellular network. To do so, it would be necessary to remove the entire active antenna module 300 from its mounting location (which is often high on an antenna tower), return the active antenna module 300 to the factory, replace the active antenna unit 310, download calibration data for the active antenna unit 310 into the radio unit 340, reassemble the active antenna module 300 and then mount the active antenna module 300 back on the antenna tower. This will often require multiple tower climbs, providing cranes at the antenna tower on multiple locations, both of which can be very expensive. However, if the radio unit 340 has an embedded scanner 370, the old active antenna unit 310 can be replaced by the new active antenna unit 310 during a single tower climb, and when the active antenna module 300 is turned on the embedded scanner 370 may be used to read the calibration data for the new active antenna unit 310 from the data storage device 200 mounted thereon. Thus, providing an embedded scanner 370 may simplify field replacement of parts of an active antenna module 300.

In the example embodiments discussed above, the filter network is shown as being part of the active antenna unit. It will be appreciated, however, that in other embodiments, the filters may be built into the radio unit, and the active antenna unit may only contain the active antenna array. The techniques described above work equally well with such active antenna modules. In this case, the calibration data may comprise amplitude and phase data for the RF transmission paths through the active antenna array.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

That which is claimed is:

1. A method of calibrating an active antenna module that includes a radio unit and an active antenna unit, the method comprising:
reading information from an electronically readable data storage device that is mounted on the active antenna unit;
connecting the radio unit to the active antenna unit; and
calibrating a radio of the radio unit using the information read from the electronically readable data storage device.

2. The method of claim 1, wherein the information read from the electronically readable data storage device comprises calibration data for the active antenna unit, the method further comprising storing the calibration data in the radio unit.

3. The method of claim 2, wherein the calibration data comprises amplitude and phase data for each of a plurality of RF transmission paths through the active antenna unit.

4. The method of claim 1, wherein the information read from the electronically readable data storage device comprises an address of a location where calibration data for the active antenna unit is electronically stored, the method further comprising downloading the calibration data and storing the downloaded calibration data in the radio unit.

5. The method of claim 4, wherein the calibration data comprises amplitude and phase data for each of a plurality of RF transmission paths through the active antenna unit.

6. The method of claim 1, wherein the electronically readable data storage device is mounted to the active antenna unit using an adhesive.

7. The method of claim 6, wherein the electronically readable data storage device comprises a barcode sticker, and the adhesive comprises an adhesive backing on the barcode sticker.

8. The method of claim 6, wherein the electronically readable data storage device comprises a QR code sticker, and the adhesive comprises an adhesive backing on the QR code sticker.

9. The method of claim 1, wherein the electronically readable data storage device comprises a near field communication tag.

10. The method of claim 1, wherein the electronically readable data storage device comprises a barcode or a QR code, and wherein reading information from the electronically readable data storage device comprises scanning the barcode or the QR code.

11. The method of claim 1, wherein the radio unit includes an embedded scanner, and wherein reading information from the electronically readable data storage device comprises using the embedded scanner to read the information from the electronically readable data storage device.

12. An active antenna unit, comprising:
an active antenna array;
a filter network coupled to the active antenna array;
an electronically readable data storage device mounted on the active antenna unit,
wherein calibration data for the active antenna array or identification of a location where the calibration data for the active antenna array is electronically accessible is stored in the electronically readable data storage device.

13. The active antenna unit of claim 12, wherein the calibration data for the active antenna array is stored in the electronically readable data storage device.

14. The active antenna unit of claim 12, wherein an address of the location where the calibration data for the active antenna array is electronically accessible is stored in the electronically readable data storage device.

15. The active antenna unit of claim 12, wherein the calibration data comprises amplitude and phase data for each of a plurality of RF transmission paths through the active antenna unit.

16. The active antenna unit of claim 12, wherein the electronically readable data storage device is mounted to the active antenna unit using an adhesive.

17. The active antenna unit of claim 16, wherein the electronically readable data storage device comprises a barcode sticker, and the adhesive comprises an adhesive backing on the barcode sticker

18. The active antenna unit of claim 12, wherein the electronically readable data storage device comprises a QR code sticker, and the adhesive comprises an adhesive backing on the QR code sticker.

19. The active antenna unit of claim 12, wherein the electronically readable data storage device comprises a near field communication tag.

20. The active antenna unit of claim 12, in combination with a radio unit that includes an embedded scanner.
